(19) United States
(12) Patent Application Publication
(10) Pub. No.: US 2013/0040202 A1
(43) Pub. Date: Feb. 14, 2013

(54) MIXED OXIDE POWDER CONTAINING THE ELEMENTS LITHIUM, MANGANESE, NICKEL AND COBALT AND METHOD FOR PRODUCING SAME

(71) Applicants: Stipan Katusic, Bad Soden (DE); Peter Kress, Karlstein (DE); Jutta Zimmermann, Alzenau (DE); Juergen Meyer, Stockstadt (DE); Hark-Oluf Asbahr, Goennheim (DE)

(72) Inventors: Stipan Katusic, Bad Soden (DE); Peter Kress, Karlstein (DE); Jutta Zimmermann, Alzenau (DE); Juergen Meyer, Stockstadt (DE); Hark-Oluf Asbahr, Goennheim (DE)

(73) Assignee: Evonik Degussa GmbH, Essen (DE)

(21) Appl. No.: 13/642,974

(22) PCT Filed: May 24, 2011
(86) PCT No.: PCT/EP11/58395

§ 371 Date: Oct. 23, 2012

(30) Foreign Application Priority Data
Jun. 25, 2010 (EP) 10167337.4

(51) Int. Cl. H01M 4/525; H01B 1/08; B82Y 30/00

(52) U.S. Cl. 429/223; 252/519.15; 977/780

(57) ABSTRACT

Mixed oxide which has the composition LiₓMn_{0.5-a} Ni_{0.5-b} Co_{a+b} O₂, where 0.8≦x≦1.2, 0.05≦a≦0.3, 0.05≦b≦0.3, −0.1≦a−b≦0.02 and a+b<0.5, and has a BET surface area of from 3 to 20 m²/g, a multimodal particle size distribution and a d₅₀ of less than or equal to 5 μm.

Mixed oxide which has the composition Lix Mn0.5−a Ni0.5−b Coa+b O2, where 0.8≦x≦1.2, 0.05≦a≦0.3, 0.05≦b≦0.3, −0.1≦a−b≦0.02 and a+b<0.5,

and has a BET surface area of from 0.05 to 1 m2/g, a d50 of less than or equal to 10 μm and a ratio of the intensities of the signals at 2Θ=18.6±1° to 2Θ=44.1±1° in the X-ray diffraction pattern of greater than or equal to 2.4.

The invention relates to a mixed oxide powder containing the elements lithium, manganese, nickel and cobalt, a process for preparing it by means of a spray pyrolysis process and also a secondary battery containing this mixed oxide powder.

EP-A-9441125 discloses a powder having the composition LiₐCo_{b}Mn_{c}Ni_{1-b-c}O₂ where 0≦a≦1.2, 0.01≦b≦0.4, 0.01≦c≦0.4 and 0.02≦b+c≦0.5, an average particle size of from 3 to 30 μm, with 10% of the particles having an average diameter of less than 1 μm, and a BET surface area of from 0.15 to 2 m²/g. The powder is obtained by thermally treating a mixture of the hydroxides of lithium, cobalt and nickel and also manganese dioxide at a temperature of 750° C. for a period of 20 hours and subsequently milling the mixture obtained.

EP-A-1295851 discloses a powder having the composition Li_{1+x+α} Ni_{(1-x-y+δ)/2}Mn_{(1-x-y-δ)/2}Co_{y}O₂ where 0≦x≦0.05, −0.05≦x+α≦0.05, 0≦y≦0.4; −0.1≦δ≦0.1, if 0≦y≦0.2, or −0.24≦δ≦0.24, if 0.2<y≦0.4. These powders display, in the X-ray diffraction pattern, the sheet structure known from lithium nitrate with signals at an angle 2Θ of about 18° (I₍₀₀₃₎) and about 44° (I₍₁₀₄₎). The ratio of the signal intensities I₍₀₀₃₎/I₍₁₀₄₎ is from 0.83 to 1.11 for 0≦y≦0.2 and 1 to 1.43 for 0.2<y≦0.4.

EP-B-1390994 discloses a mixed oxide as cathode composition for a lithium ion battery, which oxide has the formula Li(Ni_{y}Co_{1-2y}Mn_{y})O₂, where 0.167<y<0.5 and the composition is present in the form of a single phase having a 03 crystal structure which does not undergo any phase transformation to a spinel crystal structure when it is introduced into a lithium ion battery and goes through 100 full charging/discharging cycles at 30° C. and has a final capacity of 130 mAh/g using a discharging current of 30 mA/g.

EP-A-1391950 discloses a mixed oxide as positive electrode material having the composition LiₓMn_{0.5-a}Ni_{0.5-b}O₂ where 0<x<1.3, 0.05≦a≦0.3, 0.05≦b<0.3, 0.1≦a−b≦0.02 and a+b<0.5 and having a BET surface area of from 0.3 to 1.6 m²/g and a ratio of the signal intensities I₍₀₀₃₎/I₍₁₀₄₎ of from 0.95 to 1.54.

In Trans. Nonferrous Met. Soc. China 17 (2007) 897-901, Li et al. disclose a mixed oxide powder having the composition LiNi_{1/3}Co_{1/3}Mn_{1/3}O₂ and having a maximum ratio of the signal intensities I₍₀₀₃₎/I₍₁₀₄₎ of 1.62.

In Int. J. Electrochem. Sci. 2 (2007) 689-699, Periasamy et al. disclose a mixed oxide powder having the composition LiNi_{1/3}Co_{1/3}Mn_{1/3}O₂ and having a maximum ratio of the signal intensities I₍₀₀₃₎/I₍₁₀₄₎ of 1.347.

In Asia-Pac. J. Chem. Eng. 3 (2008) 527-530, Huang et al. disclose a mixed oxide powder having the composition LiNi_{1/3}Co_{1/3}Mn_{1/3}O₂ and having a ratio of the signal intensities I₍₀₀₃₎/I₍₁₀₄₎ of 1.48.

In Bull. Korean Chem. Soc. 30 (2009) 2603-2607, Jeong et al. disclose a mixed oxide powder having the composition LiNi_{1/3}Co_{1/3}Mn_{1/3}O₂ and a maximum ratio of the signal intensities I₍₀₀₃₎/I₍₁₀₄₎ of 1.38.

In Int. J. Elektrochem. Sci. 4 (2009) 1770-1778, Rambabu et al. disclose a mixed oxide powder having the composition Li_{1.10}Ni_{1/3}Co_{1/3}Mn_{1/3}O₂ and a ratio of the signal intensities I₍₀₀₃₎/I₍₁₀₄₎ of less than 1.2.

The powders mentioned are obtained by thermally treating a mixture of the hydroxides of lithium, cobalt and nickel and also manganese dioxide at a temperature of 750° C. for a period of 20 hours and subsequently milling the mixture obtained. The powders mentioned can in principle be used as cathode material for secondary batteries, but display weaknesses in respect of the capacity achieved and the discharging cycles. The technical problem addressed by the present invention was therefore to provide an improved material and also a process for preparing it.

The invention provides a mixed oxide having the composition

LiₓMn_{0.5-a}Ni_{0.5-b}Co_{a+b}O₂, where
a) 0.8≦x≦1.2, preferably 0.9≦x≦1.1, particularly preferably x=1
   0.05≦a≦0.3, preferably 0.1≦a≦0.2, particularly preferably a=1/6
   0.05≦b≦0.3, preferably 0.1≦b≦0.2, particularly preferably b=1/6
   −0.1≦a−b≦0.02, preferably a=b
   a+b<0.5, preferably 0.15≦a+b<0.4, and having
b) a BET surface area of from 3 to 20 m²/g, preferably from 4 to 10 m²/g,
c) a multimodal particle size distribution and
d) a d₅₀ of less than or equal to 5 μm, preferably from 0.5 to 4 μm, particularly preferably from 0.8 to 2 μm.

For the purposes of the present invention, this mixed oxide will be referred to as mixed oxide A. For the present purposes, a mixed oxide is the intimate mixture of all mixed oxide components. It is accordingly largely a mixture on the atomic level, not a physical mix of oxides. For the purposes of the invention, the terms mixed oxide, mixed oxide powder and mixed oxide particles are used synonymously. The mixed oxide particles are generally present in the form of aggregated primary particles.

The BET surface area is determined in accordance with DIN ISO 9277. The macropore volume (Hg porosimetry) is determined in accordance with DIN 66133.

The d₅₀ results from the cumulative distribution curve of the volume-average size distribution. This is usually determined by laser light scattering methods. For the purposes of the present invention, the instrument used here is a Cilas 1064 instrument made by Cilas. A d₅₀ is the value at which 50% of the mixed oxide particles A are within the size range indicated. A d₉₀ is the value at which 90% of the mixed oxide particles A are within the size range indicated. A d₉₉ is the value at which 99% of the mixed oxide particles A are within the size range indicated. The d₉₀ of the mixed oxide particles A of the invention can preferably be from 1 to 10 μm, particularly preferably from 2 to 5 μm. The d₉₉ of the mixed oxide particles A of the invention can preferably be from 3 to 15 μm, particularly preferably from 4 to 8 μm.

For the purpose of the present invention, multimodality is a particle size distribution having two or more clearly discernible maxima in a histogram. A bimodal particle size distribution is a frequency distribution having precisely two maxima. In a particular embodiment of the invention, the mixed oxide powder A has a bimodal or trimodal particle size distribution.

It is advantageous for there to be a maximum in the range from 0.1 to 1 μm and a maximum, in the case of a bimodal particle size distribution, or a plurality of maxima, in the case of a multimodal particle size distribution, in the range, in each case, from 2 to 8 μm.

Furthermore, it can be advantageous for the maximum in the range from 0.1 to 1 μm to make up less than 50% of the volume-average size distribution.

The invention further provides a process for preparing the mixed oxide A, in which
a) a stream of a solution containing in each case at least one metal compound of the mixed oxide components comprising lithium, cobalt, manganese and nickel in the required stoichiometric ratio is atomized by means of an atomizer gas to give an aerosol, where
   a1) the concentration of the solution of metal compounds is at least 10% by weight, preferably from 10 to 20% by weight, particularly preferably from 12 to 18% by weight, in each case calculated as metal oxide,
   a2) the ratio of the mass stream of the solution/volume stream of the atomizer gas, in g of solution/standard m³ of atomizer gas, is at least 500, preferably from 500 to 3000, particularly preferably from 600 to 1000, and
   a3) the average droplet size is 100 μm or less, preferably from 30 to 100 μm,
b) the aerosol is reacted in a reaction space by means of a flame obtained from a fuel gas and an oxygen-containing gas, in general air or oxygen-enriched air, with the total amount of oxygen being sufficient for at least complete reaction of the fuel gas and of the metal compounds,
c) the reaction stream is cooled and
d) the solid product is subsequently separated off from the reaction stream.

Furthermore, it has been found that mixed oxides A which are particularly good for use in secondary batteries in respect of the capacity and the charging/discharging cycles which can be achieved are obtained when
a high average exit velocity of the aerosol into the reaction space, preferably at least 50 ms⁻¹, particularly preferably from 100 to 300 ms⁻¹, prevails and/or
a low average velocity of the reaction mixture in the reaction space, preferably from 0.1 ms⁻¹ to 10 ms⁻¹, particularly preferably from 1 to 5 ms⁻¹, prevails.

It is essential to the present invention that the metal compounds are present in a solution. To achieve solubility and to attain a suitable viscosity for atomization of the solution, the solution can be heated. It is in principle possible to use all soluble metal compounds which are oxidizable. These can be inorganic metal compounds such as nitrates, chlorides, bromides or organic metal compounds such as alkoxides or carboxylates. As alkoxides, preference is given to using a ethoxides, n-propoxides, isopropoxides, n-butoxides and/or tert-butoxides. As carboxylates, it is possible to use the compounds based on acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid and/or lauric acid. 2-ethylhexanoates or laurates can be used particularly advantageously. The solution can contain one or more inorganic metal compounds, one or more organic metal compounds or mixtures of inorganic and organic metal compounds.

The solvents can preferably be selected from the group consisting of water, C₅-C₂₀-alkanes, C₁-C₁₅-alkanecarboxylic acids and C₁-C₁₅-alkanols. Particular preference is given to using water or a mixture of water and an organic solvent.

As organic solvents or as constituents of organic solvent mixtures, preference is given to using alcohols such as methanol, ethanol, n-propanol, isopropanol, n-butanol or tert-butanol, diols such as ethanediol, pentanediol, 2-methyl-2,4-pentanediol, C₁-C₁₂-carboxylic acids such as acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid, lauric acid. It is also possible to use benzene, toluene, naphtha and/or petroleum spirit.

In the process of the invention, the amount of oxygen is selected so that it is sufficient for at least complete reaction of the fuel gas and of the metal compounds. It is generally advantageous to use an excess of oxygen. This excess is advantageously expressed as the ratio of oxygen present/oxygen required for combustion of the fuel gas and denoted as lambda. Lambda is preferably from 1.8 to 4.0. Suitable fuel gases can be hydrogen, methane, ethane, propane, butane and mixtures thereof. Preference is given to using hydrogen.

The invention further provides a mixed oxide which has the composition

LiₓMn_{0.5-a}Ni_{0.5-b}Co_{a+b}O₂,
a) where 0.8≦x≦1.2, preferably 0.9≦x≦1.1, particularly preferably x=1
   0.05≦a≦0.3, preferably 0.1≦a≦0.2, particularly preferably a=1/6
   0.05≦b<0.3, preferably 0.1≦b≦0.2, particularly preferably b=1/6
   −0.1≦a−b≦0.02, preferably a=b
   a+b<0.5, preferably 0.15≦a+b≦0.4, and has
b) a BET surface area of from 0.05 to 1 m²/g, preferably from 0.1 to 0.5 m²/g,
c) a d₅₀ of less than or equal to 10 μm, preferably from 0.5 to 6 μm, particularly preferably from 1 to 4 μm, and in which
d) the ratio of the intensities of the signals at 2Θ=18.6±1° to 2Θ=44.1±1° in the X-ray diffraction pattern is greater than or equal to 2.4, preferably from 2.4 to 5.

For the purposes of the present invention, this mixed oxide will be referred to as mixed oxide B. It differs from mixed oxide A in that it has, inter alia, a higher crystallinity.

The d₉₀ of the mixed oxide particles B of the invention can preferably be from 2 to 20 μm, particularly preferably from 3 to 10 μm. The d₉₉ of the mixed oxide particles B of the invention can preferably be from 3 to 30 μm, particularly preferably from 4 to 20 μm.

Mixed oxide B is characterized by a ratio of the intensities of the signals at 2Θ=18.6±1° to 2Θ=44.1±1° of greater than or equal to 2.4. It is assumed that this value, which is high compared to the values known in the prior art, is an important factor in achieving the good properties of the mixed oxide B as constituent of secondary batteries. The X-ray data are determined by means of a PANanalytical X'Pert PRO diffractometer using Cu—K_{α} radiation in a 2 Θ (2 theta) range of 10-100° at a scan rate of 0.017°/step, measurement time of 80 s/step, corresponding to 0.0265°/s. The evaluation was carried out by means of the Rietveld refinement.

Mixed oxide B preferably has a width at half height of the signal, determined by means of X'Pert Data Viewer software, at

2Θ=18.6±1° of from >0.20 to 0.40, preferably from 0.22 to 0.32, and at
Θ=44.1±1° of from 0.25 to 0.40, preferably from 0.27 to 0.35.

Furthermore, mixed oxide B preferably has a hexagonal crystal lattice structure in the R3m space group. The lattice constant a satisfies

2.860≦a≦2.900, preferably 2.865≦a≦2.890
and the lattice constant c satisfies
14.200≦c≦14.320, preferably 14.250≦c≦14.280,
all in Angstrom, where, furthermore,
1.650≦c/3a≦1.660, preferably 1.662≦c/3a≦1.658.

Furthermore, mixed oxide B shows a volume of pores having a diameter of more than 50 nm of preferably from 0.3 to 1.2 ml/g and particularly preferably from 0.4 to 0.9 ml/g. The pore volume is determined by Hg intrusion.

The invention further provides a process for preparing the mixed oxide B, in which the mixed oxide A is thermally treated at temperatures of from 500 to 1100° C., preferably from 900 to 1050° C., for a period of from 2 to 36 hours.

The preparation of the mixed oxide B thus encompasses the process steps for preparing the mixed oxide A. Overall, the preparation of the mixed oxide B comprises a process in which
a) a stream of a solution containing in each case at least one metal compound of the mixed oxide components comprising lithium, cobalt, manganese and nickel in the required stoichiometric ratio is atomized by means of an atomizer gas to give an aerosol, where
   a1) the concentration of the solution of metal compounds is at least 10% by weight, preferably from 10 to 20% by weight, particularly preferably from 12 to 18% by weight, in each case calculated as metal oxide,
   a2) the ratio of the mass stream of the solution/volume stream of the atomizer gas, in g of solution/standard m³ of atomizer gas, is at least 500, preferably from 500 to 3000, particularly preferably from 600 to 1000, and
   a3) the average droplet size is 100 μm or less, preferably from 30 to 100 μm,
b) the aerosol is reacted in a reaction space by means of a flame obtained from a fuel gas and an oxygen-containing gas, in general air or oxygen-enriched air, with the total amount of oxygen being sufficient for at least complete reaction of the fuel gas and of the metal compounds,
c) the reaction stream is cooled and
d) the solid product is subsequently separated off from the reaction stream and
e) is thermally treated at from 500 to 1100° C. for a period of from 2 to 36 hours.

The invention further provides a secondary battery which contains the mixed oxide powder of the invention as material of the positive electrode.

### EXAMPLES

### Mixed Oxide Powder A

Solutions used: for Examples 1 to 6, a solution containing the salts mentioned in Table 1 is in each case produced using water or 2-ethylhexanoic acid (2-EHA) as solvent.

An aerosol is produced from the solution and atomizer air by means of a nozzle and is atomized into a reaction space. Here, an H₂/O₂ flame from hydrogen and air burns and the aerosol is reacted in this. After cooling, the mixed oxide powder A is separated off from gaseous materials on a filter.

### Mixed Oxide Powder B

The mixed oxide powders A are subsequently thermally treated for a particular period of time in a furnace.

Table 1 reports all relevant parameters for preparing the mixed oxide powders and also important materials properties of the powders obtained.

TABLE 1
Mixed oxide powders A having the composition Liₓ Mn_{0.5-a} Ni_{0.5-b} Co_{a+b} O₂

| Example | | 1 | 2 | 3 | 4 | 5 | 6 |
|---|---|---|---|---|---|---|---|
| x | | 1.10 | 0.96 | 0.93 | 0.96 | 1.00 | 0.85 |
| a | | 0.15 | 0.19 | 0.16 | 0.17 | 0.18 | 0.15 |
| b | | 0.23 | 0.17 | 0.17 | 0.10 | 0.09 | 0.23 |
| Lithium acetate | % by | 1.08 | 1.15 | 1.15 | 1.21 | 1.21 | — |
| | weight | | | | | | |
| Lithium octoate | % by | — | — | — | — | — | 4.68 |
| | weight | | | | | | |
| Nickel(II) acetate | % by | 3.03 | — | — | — | — | — |
| | weight | | | | | | |
| Nickel(II) nitrate | % by | — | 3.20 | 3.20 | 4.02 | 4.02 | — |
| | weight | | | | | | |
| Nickel(II) octoate | % by | — | — | — | — | — | 6.94 |
| | weight | | | | | | |
| Manganese(II) | % by | 2.84 | — | — | — | — | — |
| acetate | weight | | | | | | |
| Manganese(II) | % by | — | 2.99 | 2.99 | 2.89 | 2.89 | — |
| nitrate | weight | | | | | | |
| Manganese(II) | % by | — | — | — | — | — | 6.47 |
| octoate | weight | | | | | | |
| Cobalt(II) acetate | % by | 3.04 | — | — | — | — | — |
| | weight | | | | | | |
| Cobalt(II) nitrate | % by | — | 3.21 | 3.21 | 2.17 | 2.17 | — |
| | weight | | | | | | |
| Cobalt(II) octoate | % by | — | — | — | — | — | 7.75 |
| | weight | | | | | | |
| Solvent | | H₂O | H₂O | H₂O | H₂O | H₂O | 2-EHA |
| Viscosity¹⁾ | mPas | 5 | 6.5 | 6.5 | 8.0 | 7.5 | 290 |
| Σ MeX²⁾ | % by | 14.47 | 15.18 | 15.18 | 14.91 | 14.91 | 10.71 |
| | weight | | | | | | |
| m′ₛₒₗ³⁾ | g/h | 2500 | 2000 | 1500 | 1500 | 1800 | 2000 |
| m′_{at. air}⁴⁾ | standard | 1.0 | 2.5 | 2.5 | 2.5 | 2.5 | 2.0 |
| | m³/h | | | | | | |
| m′ₛₒₗ/m′_{at. air} | g/stan- | 2500 | 800 | 600 | 600 | 720 | 1000 |
| | dard m³ | | | | | | |
| v₁⁵⁾ | m/s | 88.4 | 221.0 | 221.0 | 221.0 | 221.0 | 176.8 |
| d₉₀⁶⁾ | μm | 87 | 92 | 91 | 89 | 93 | 96 |
| Hydrogen | standard | 4.6 | 5.5 | 5.5 | 5.5 | 5.5 | 8 |
| | m³/h | | | | | | |
| Air | standard | 26 | 25 | 25 | 25 | 25 | 28 |
| | m³/h | | | | | | |
| Lambda | | 2.37 | 1.87 | 1.87 | 1.87 | 1.87 | 1.47 |
| v₂⁷⁾ | m/s | 2.44 | 2.44 | 2.39 | 2.39 | 2.42 | 2.46 |
| t₂⁸⁾ | s | 1.23 | 1.23 | 1.26 | 1.26 | 1.24 | 1.22 |
| T_{FI1}⁹⁾/T_{FI2}¹⁰⁾ | ° C. | 826/571 | 874/602 | 912/635 | 907/614 | 896/632 | 1005/751 |
| BET surface | m²/g | 8.0 | 5.3 | 5.2 | 4.0 | 8.0 | 16.0 |
| area | | | | | | | |
| Particle size | μm/% | trimodal | bimodal | bimodal | trimodal | trimodal | bimodal |
| distribution | | 0.7/22.7 | 1.9/48.8 | 1.9/56.2 | 0.7/23.2 | 0.8/23.0 | 2.1/51.6 |
| Max₁/proportion | | 1.8/30.0 | 8.0/51.2 | 8.5/43.8 | 1.8/31.1 | 1.9/30.8 | 7.5/48.4 |
| Max₂/proportion | | 7.0/47.3 | —/— | —/— | 7.3/45.7 | 7.5/46.2 | —/— |
| Max₃/proportion | | | | | | | |
| d₅₀ | | 0.967 | 1.421 | 1.371 | 1.621 | 0.927 | 1.05 |
| d₉₀ | μm | 2.435 | 4.112 | 3.945 | 4.057 | 2.654 | 2.43 |
| d₉₉ | | 5.311 | 6.037 | 5.783 | 6.372 | 5.112 | 6.01 |

TABLE 2
Mixed oxide powder B having the composition Liₓ Mn_{0.5-a} Ni_{0.5-b} Co_{a+b} O₂

| Example | | 1 | 2 | 3 | 4 | 5 | 6 | 7¹¹⁾ | 8¹¹⁾ |
|---|---|---|---|---|---|---|---|---|---|
| T_{furnace} | ° C. | 1050 | 925 | 925 | 950 | 950 | 1020 | — | — |
| t_{heat treatment} | h | 20 | 4 | 4 | 4 | 4 | 12 | — | — |
| BET | m²/g | 0.1 | 0.1 | 0.1 | 0.2 | 0.1 | 0.7 | 0.4 | 0.27 |
| I_{18.6°} | | 8470 | 13540 | 12380 | 18800 | 12130 | 4430 | 15020 | 12230 |
| I_{44.1°} | | 3080 | 4960 | 5130 | 4100 | 4090 | 1750 | 7200 | 7110 |
| I_{18.6°}/I_{44.1°}¹²⁾ | | 2.75 | 2.73 | 2.41 | 4.59 | 2.97 | 2.57 | 2.09 | 1.72 |
| WHH_{18.6°}¹³⁾ | | 0.31 | 0.24 | 0.22 | 0.22 | 0.26 | n.d.¹⁴⁾ | n.d. | n.d. |
| WHH_{44.1°}¹³⁾ | | 0.31 | 0.27 | 0.25 | 0.33 | 0.34 | n.d. | n.d. | n.d. |
| a | \acute{Å} | 2.854 | 2.868 | 2.874 | 2.889 | 2.872 | 2.850 | 2.859 | 2.858 |
| c | \acute{Å} | 14.212 | 14.264 | 14.275 | 14.319 | 14.264 | 14.226 | 14.233 | 14.227 |
| c/3a | | 1.656 | 1.658 | 1.656 | 1.652 | 1.656 | 1.664 | 1.659 | 1.659 |
| V_{macropores} | ml/g | 0.30 | 0.43 | 0.64 | 0.43 | 0.50 | 0.89 | n.d. | n.d. |
| d₅₀ | μm | 5.5 | 1.4 | 2.2 | 3.6 | 1.2 | 3.5 | 6.66 | 8.52 |
| d₉₀ | | 10.0 | 3.0 | 4.99 | 6.2 | 2.7 | 8.0 | 9.53 | 12.44 |
| d₉₉ | | 14.7 | 4.5 | 8.6 | 8.4 | 4.0 | 16.1 | 12.65 | 16.82 |

Explanations for Tables 1 and 2:
¹⁾viscosity at 20° C.; in accordance with DIN ISO 3219
²⁾as oxides
³⁾m′ₛₒₗ = mass stream of solution
⁴⁾m′_{at. air} = volume stream of atomizer air
⁵⁾v₁ = average exit velocity of the aerosol into the reaction space;
⁶⁾d₉₀ of the droplets in aerosol production
⁷⁾v₂ = average velocity in the reactor;
⁸⁾t₂ = average residence time in the reactor;
⁹⁾T_{FI1} = 50 cm from burner mouth;
¹⁰⁾T_{FI2} = 200 cm from burner mouth;
¹¹⁾commercially available mixed oxide powder having the composition LiNi_{1/3}Mn_{1/3}Co_{1/3}O₂
¹²⁾ratio of the intensities of the signals at 2Θ = 18.6 ± 1° to 2Θ = 44.1 ± 1°;
¹³⁾width at half height of the signals at 2Θ = 18.6 ± 1° and 2Θ = 44.1 ± 1°
¹⁴⁾n.d. = not determined

1. A mixed oxide comprising a composition of LiₓMn_{0.5-a} Ni_{0.5-b} Co_{a+b} O₂,
wherein:
a) in the composition
0.8≦x≦1.2,
0.05≦a≦0.3,
0.05≦b<0.3,
−0.1≦a−b≦0.02, and
a+b<0.5;
b) the mixed oxide has a BET surface area of from 3 to 20 m²/g;
c) a multimodal particle size distribution; and
d) a d₅₀ of less than or equal to 5 μm.

2. The mixed oxide of claim 1, wherein the multimodal particle size distribution is a bimodal or trimodal particle size distribution.

3. The mixed oxide, of claim 1, wherein the particle size distribution has a maximum in the range from 0.1 to 1 μm and a maxima in the range from 2 to 8 μm.

4. The mixed oxide of claim 3, wherein the maxima in the range from 0.1 to 1 μm comprises less than 50% of the volume-average particle size distribution.

5. A process for preparing the mixed oxide of claim 1, the process comprising:
a) atomizing, with an atomizer gas, a stream of a solution comprising a solvent and in each case a metal compound of the mixed oxide components comprising lithium, cobalt, manganese, and nickel in the required stoichiometric ratio, to give an aerosol, wherein
a1) the concentration of the solution of metal compounds is at least 10% by weight, in each case calculated as metal oxide,
a2) a ratio of the mass stream of the solution/volume stream of the atomizer gas, in g of solution/standard m³ of atomizer gas, is at least 500, and
a3) the average droplet size is 100 μm or less;
b) reacting the aerosol in a reaction space with a flame obtained from a fuel gas and an oxygen-comprising gas, with the total amount of oxygen being sufficient for at least complete reaction of the fuel gas and of the metal compounds;
c) cooling the reaction stream; and subsequently
d) separating a solid product off from the reaction stream.

6. The process of claim 5, wherein the average exit velocity of the aerosol into the reaction space is at least 50 ms⁻¹ and the average velocity of the reaction mixture in the reaction space is from 0.1 ms⁻¹ to 10 ms⁻¹.

7. The process, of claim 5, wherein the metal compound is an inorganic metal compound, an organic metal compound, or a mixture thereof.

8. The process of claim 5, wherein the solvent is at least one selected from the group consisting of water, a C₅-C₂₀-alkane, a C₁-C₁₅-alkanecarboxylic acid, and a C₁-C₁₅-alkanol.

9. The process of claim 5, wherein lambda, which is a ratio of oxygen present to oxygen required for combustion of the fuel gas, is from 1.8 to 4.0.

10. A mixed oxide comprising a composition of Liₓ Mn_{0.5-a} Ni_{0.5-b} Co_{a+b} O₂,
wherein
a) in the composition
0.8≦x≦1.2,
0.05≦a≦0.3,
0.05≦b<0.3,
−0.1≦a−b≦0.02, and
a+b<0.5;
b) the mixed oxide has a BET surface area of from 0.05 to 1 m²/g;
c) the d₅₀ is less than or equal to 10 μm; and
d) a ratio of a signal intensity at 2θ=18.6±1° to a signal intensity at 2θ=44.1±1° in the X-ray diffraction pattern is greater than or equal to 2.4.

11. The mixed oxide of claim 10, wherein the width at half height of the signal at 2θ=18.6±1°>0.20 to 0.40 and at 2θ=44.1±1° is from 0.25 to 0.40.

12. The mixed oxide of claim 10, having a hexagonal crystal lattice structure in the R3m space group having lattice constants a and c, wherein 2.860≦a≦2.900 and 14.200≦c≦14.320, all in Angstrom.

13. The mixed oxide of claim 10, comprising a volume of pores having a diameter of more than 50 nm of from 0.30 to 1.20 ml/g.

14. The mixed oxide of claim 10, wherein the d₅₀ is from 1 to 10 μm.

15. The process for preparing the mixed oxide of claim 10, the process comprising thermally treating a mixed oxide at a temperature in a range, from 500 to 1100° C. for a period of from 2 to 36 hours,
wherein the mixed oxide is a mixed oxide comprising a composition of LiₓMn_{0.5-a}Ni_{0.5-b} Co_{a+b} O₂,
wherein:
a) in the composition
0.8≦x≦1.2,
0.05≦a≦0.3,
0.05≦b<0.3,
−0.1≦a−b≦0.02, and
a+b<0.5;
b) the mixed oxide has a BET surface area of from 3 to 20 m²/g;
c) a multimodal particle size distribution; and
d) a d₅₀ of less than or equal to 5 μm.

16. A secondary battery comprising a positive electrode comprising the mixed oxide of claim 12.
